(19) United States
(12) Patent Application Publication
(10) Pub. No.: US 2020/0045341 A1
(43) Pub. Date: Feb. 6, 2020

(54) EFFECTIVE ELECTRO-OPTICAL TRANSFER FUNCTION ENCODING FOR LIMITED LUMINANCE RANGE DISPLAYS

(71) Applicant: ATI Technologies ULC, Markham (CA)

(72) Inventors: Anthony Wai Lap Koo, Aurora (CA); Syed Athar Hussain, Scarborough (CA); Krunoslav Kovac, North York (CA)

(21) Appl. No.: 16/050,556

(22) Filed: Jul. 31, 2018

(51) Int. Cl. H04N 19/85; H04N 19/124; H04N 19/182; H04N 19/433; H04N 19/98

(52) U.S. Cl. CPC H04N 19/85; H04N 19/124; H04N 19/98; H04N 19/433; H04N 19/182

(57) ABSTRACT

Systems, apparatuses, and methods for implementing an effective electro-optical transfer function for limited luminance range displays are disclosed. A processor detects a request to generate pixel data for display. The processor also receives an indication of an effective luminance range of a target display. The processor encodes pixel data of an image or video frame into a format which matches the effective luminance range of the target display. In one implementation, the processor receives encoded pixel data in a first format, wherein the first format has unused output pixel values which map to luminance values outside of the effective luminance range of the target display. The processor converts the encoded pixel data from the first format into encoded pixel data of a second format which matches the effective luminance range of the target display. A decoder then decodes the encoded pixel data and drives the decoded pixel data to the target display.

### BACKGROUND

### Description of the Related Art

Many types of computer systems include display devices to display images, video streams, and data. Accordingly, these systems typically include functionality for generating and/or manipulating images and video information. In digital imaging, the smallest item of information in an image is called a “picture element” and more generally referred to as a “pixel.” To represent a specific color on a typical electronic display, each pixel can have three values, one each for the amounts of red, green, and blue present in the desired color. Some formats for electronic displays may also include a fourth value, called alpha, which represents the transparency of the pixel. This format is commonly referred to as ARGB or RGBA. Another format for representing pixel color is YCbCr, where Y corresponds to the luminance, or brightness, of a pixel and Cb and Cr correspond to two color-difference chrominance components, representing the blue-difference (Cb) and red-difference (Cr).

Luminance is a photometric measure of the luminous intensity per unit area of light travelling in a given direction. Luminance describes the amount of light that is emitted or reflected from a particular area. Luminance indicates how much luminous power will be detected by an eye looking at a surface from a particular angle of view. One unit used to measure luminance is a candela per square meter. A candela per square meter is also referred to as a “nit”.

Based on studies of human vision, there is some minimum change in luminance in order for humans to detect a difference in luminance. For high dynamic range (HDR) type content, video frames are typically encoded using a perceptual quantizer electro-optical transfer function (PQ-EOTF) to cause adjacent code words to be close to the minimum step in perceivable brightness. Typical HDR displays use 10-bit color depth, meaning each color component can range from values of 0-1023. With 10-bit encoded PQ EOTF, each of the 1024 code words represent some luminance from 0-10000 nits, but based on human perception it is possible to have more luminance levels that can be differentiated from these 1024 levels. With 8 bit color depth per component, there are only 256 code words, thus each jump in luminance is even more obvious if only 8 bits are used to describe the entire 0-10000 nits range. When using the PQ-EOTF to encode video frames, an output pixel value of zero represents a minimum luminance of 0 nits and the maximum output pixel value (e.g., 1023 for a 10-bit output value) represents a maximum luminance of 10,000 nits. However, typical displays in use today are not able to reach up to that brightness level. Accordingly, displays are not able to represent some of the luminance values that are encoded in the video frame.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of one implementation of a system for encoding a video bitstream which is sent over a network.

FIG. 3 is a block diagram of another implementation of computing system.

FIG. 4 illustrates a diagram of one implementation of a graph plotting a 10-bit video output pixel value versus luminance.

FIG. 5 illustrates a diagram of one implementation of a graph of gamma and perceptual quantizer (PQ) electro-optical transfer function (EOTF) curves.

FIG. 6 illustrates a diagram of one implementation of a graph for remapping pixel values to a format adapted to a target display.

FIG. 7 is a generalized flow diagram illustrating one implementation of a method for using an effective electro-optical transfer function for limited luminance range displays.

FIG. 8 is a generalized flow diagram illustrating one implementation of a method for performing format conversion for pixel data.

FIG. 9 is a generalized flow diagram illustrating one implementation of a method for processing pixel data.

FIG. 10 is a generalized flow diagram illustrating one implementation of a method selecting a transfer function for encoding pixel data.

FIG. 11 is a block diagram of one implementation of a computing system.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, and methods for implementing an effective electro-optical transfer function for limited luminance range displays are disclosed herein. A processor (e.g., graphics processing unit (GPU)) detects a request to encode pixel data to be displayed. The processor also receives an indication of the effective luminance range of a target display. In response to receiving the indication, the processor encodes the pixel data in a format which maps to the effective luminance range of the target display. In other words, the format has a lowest output pixel value which maps to the minimum luminance value able to be displayed by the target display, and the format has a highest output pixel value which maps to the maximum luminance value able to be displayed by the target display.

In one implementation, a processor receives pixel data in a first format which has one or more output pixel values which map to luminance values outside of the effective luminance range of the target display. Accordingly, these output pixel values are not able to convey any useful information. The processor converts the pixel data from the first format to a second format which matches the effective luminance range of the target display. In other words, the processor rescales the pixel representation curve, such that all values that are transmitted to the target display are values that the target display can actually output. A decoder then decodes the pixel data of the second format and then the decoded pixel data is driven to the target display.

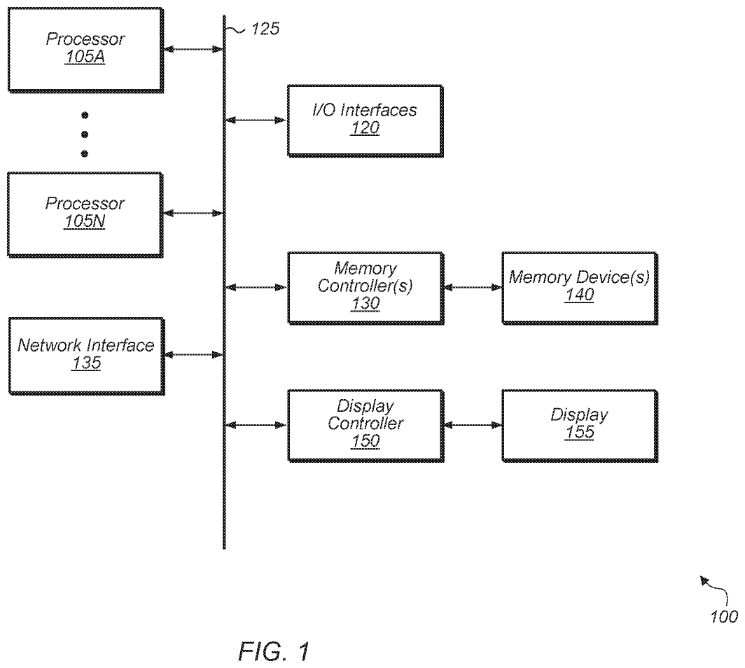

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides a plurality of pixels to display controller 150 to be driven to display 155.

Memory controller(s) 130 are representative of any number and type of memory controllers accessible by processors 105A-N and I/O devices (not shown) coupled to I/O interfaces 120. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

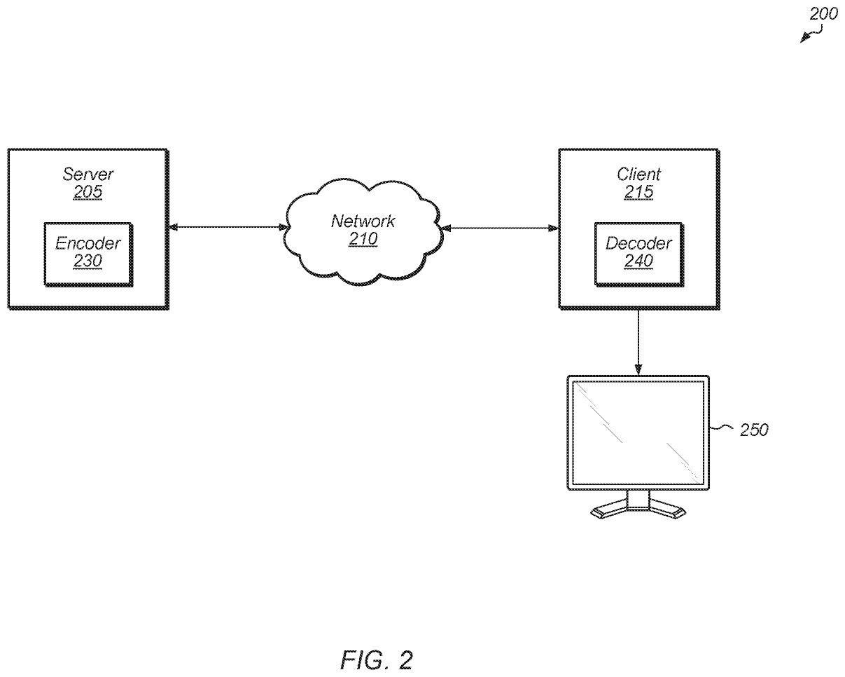

Turning now to FIG. 2, a block diagram of one embodiment of a system 200 for encoding a video bitstream which is sent over a network is shown. System 200 includes server 205, network 210, client 215, and display 220. In other embodiments, system 200 can include multiple clients connected to server 205 via network 210, with the multiple clients receiving the same bitstream or different bitstreams generated by server 205. System 200 can also include more than one server 205 for generating multiple bitstreams for multiple clients. In one embodiment, system 200 is configured to implement real-time rendering and encoding of video content. In other embodiments, system 200 is configured to implement other types of applications. In one embodiment, server 205 renders video or image frames and then encoder 230 encodes the frames into a bitstream. The encoded bitstream is then conveyed to client 215 via network 210. Decoder 240 on client 215 decodes the encoded bitstream and generate video frames or images to drive to display 250.

Network 210 is representative of any type of network or combination of networks, including wireless connection, direct local area network (LAN), metropolitan area network (MAN), wide area network (WAN), an Intranet, the Internet, a cable network, a packet-switched network, a fiber-optic network, a router, storage area network, or other type of network. Examples of LANs include Ethernet networks, Fiber Distributed Data Interface (FDDI) networks, and token ring networks. In various implementations, network 210 further includes remote direct memory access (RDMA) hardware and/or software, transmission control protocol/internet protocol (TCP/IP) hardware and/or software, router, repeaters, switches, grids, and/or other components.

Server 205 includes any combination of software and/or hardware for rendering video/image frames and encoding the frames into a bitstream. In one embodiment, server 205 includes one or more software applications executing on one or more processors of one or more servers. Server 205 also includes network communication capabilities, one or more input/output devices, and/or other components. The processor(s) of server 205 include any number and type (e.g., graphics processing units (GPUs), CPUs, DSPs, FPGAs, ASICs) of processors. The processor(s) are coupled to one or more memory devices storing program instructions executable by the processor(s). Similarly, client 215 includes any combination of software and/or hardware for decoding a bitstream and driving frames to display 250. In one embodiment, client 215 includes one or more software applications executing on one or more processors of one or more computing devices. Client 215 can be a computing device, game console, mobile device, streaming media player, or other type of device.

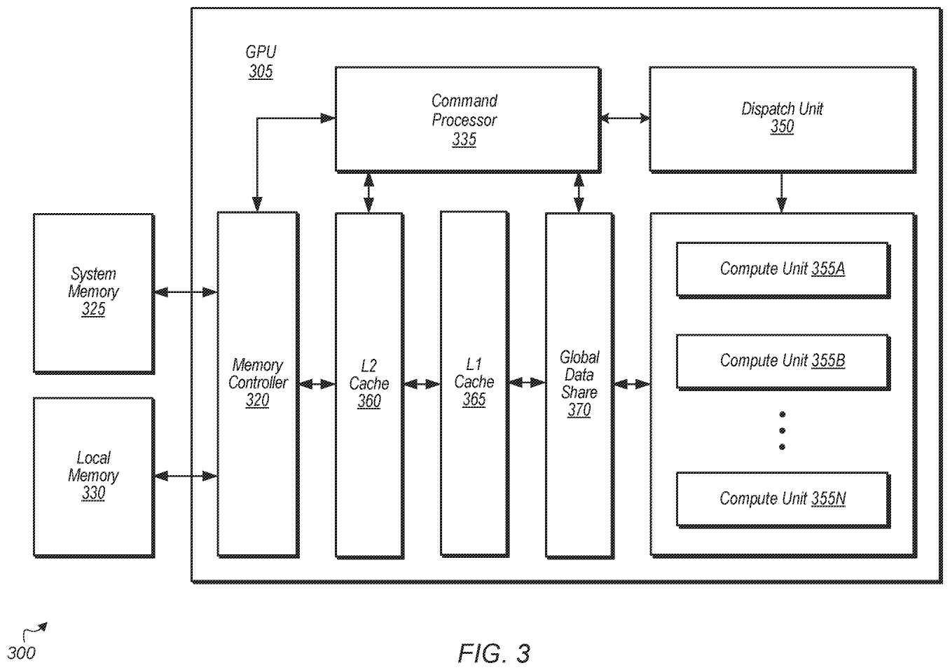

Referring now to FIG. 3, a block diagram of another implementation of a computing system 300 is shown. In one implementation, system 300 includes GPU 305, system memory 325, and local memory 330. System 300 also includes other components which are not shown to avoid obscuring the figure. GPU 305 includes at least command processor 335, dispatch unit 350, compute units 355A-N, memory controller 320, global data share 370, level one (L1) cache 365, and level two (L2) cache 360. In other implementations, GPU 305 includes other components, omits one or more of the illustrated components, has multiple instances of a component even if only one instance is shown in FIG. 3, and/or is organized in other suitable manners.

In various implementations, computing system 300 executes any of various types of software applications. In one implementation, as part of executing a given software application, a host CPU (not shown) of computing system 300 launches kernels to be performed on GPU 305. Command processor 335 receives kernels from the host CPU and issues kernels to dispatch unit 350 for dispatch to compute units 355A-N. Threads within kernels executing on compute units 355A-N read and write data to global data share 370, L1 cache 365, and L2 cache 360 within GPU 305. Although not shown in FIG. 3, in one implementation, compute units 355A-N also include one or more caches and/or local memories within each compute unit 355A-N.

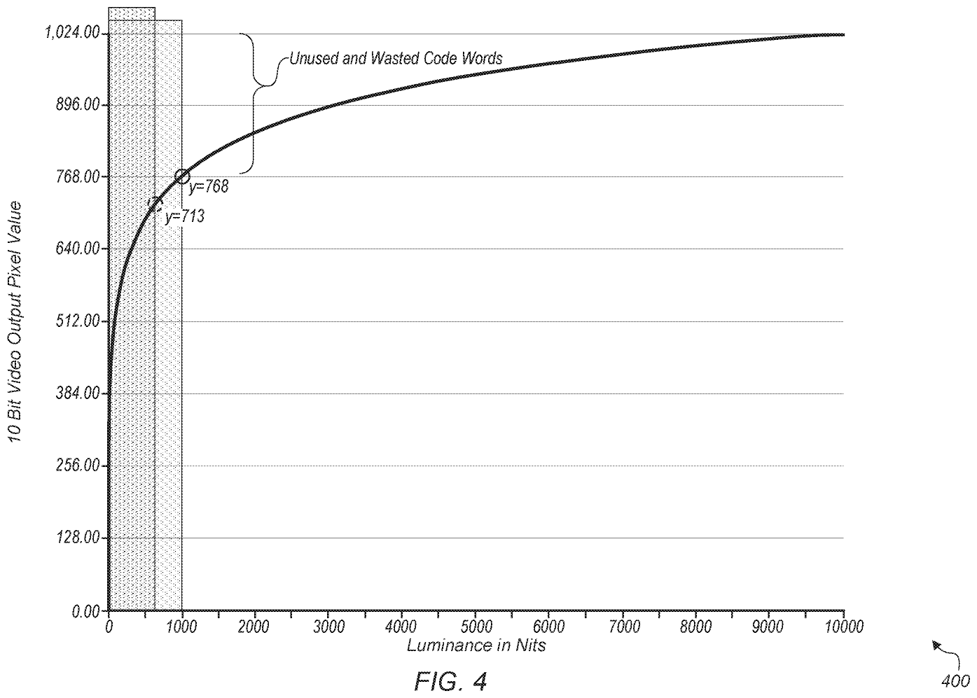

Turning now to FIG. 4, a diagram of one implementation of a graph 400 plotting a 10-bit video output pixel value versus luminance is shown. In one implementation, a 10-bit video output pixel value generated by a video source includes a lowest output value which maps to 0 nits and a highest output value which maps to 10000 nits. This 10-bit video output pixel value plotted versus luminance in nits is shown in graph 400. It is noted that an “output pixel value” is also referred to as a “code word” herein.

Many displays are not able to generate a maximum luminance of 10000 nits. For example, some displays are only able to generate a maximum luminance of 600 nits. Using the curve shown in graph 400, a luminance of 600 nits corresponds to a 10-bit pixel value of 713. This means that for a display that has a maximum luminance of 600 nits, all output pixel values greater than 713 are wasted because these values will result in a luminance output of 600 nits. In another example, other types of displays are only able to generate a maximum luminance of 1000 nits. A pixel value of 768 corresponds to a luminance of 1000 nits, and so for a display that has a maximum luminance output of 1000 nits, all output pixel values greater than 768 are wasted.

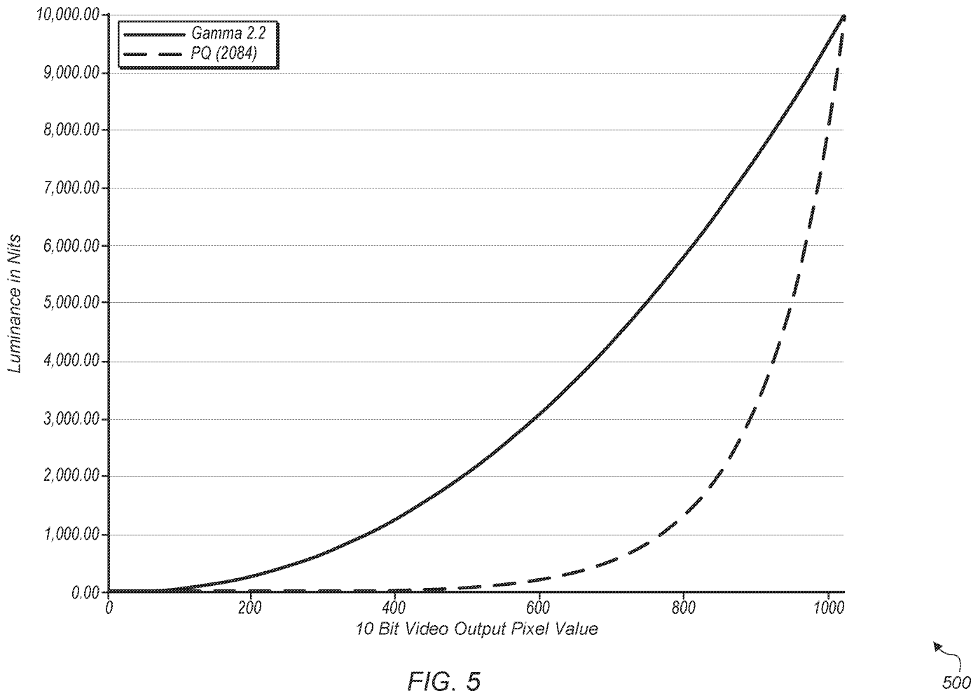

Referring now to FIG. 5, a diagram of one implementation of a graph 500 of gamma and perceptual quantizer (PQ) electro-optical transfer function (EOTF) curves is shown. The solid line in graph 500 represents a gamma 2.2 curve plotted on an x-axis of 10-bit video output pixel value versus a y-axis of luminance in nits. The dashed line in graph 500 represents a PQ curve, which is also known as the ST.2084 standard and which covers 0 to 10,000 nits. For high dynamic range (HDR) displays, gamma encoding will often result in quantization errors. Accordingly, in one implementation, a PQ EOTF encoding is used to reduce the quantization errors. Compared with the gamma 2.2 curve, the PQ curve increases more slowly with more levels in the low luminance range.

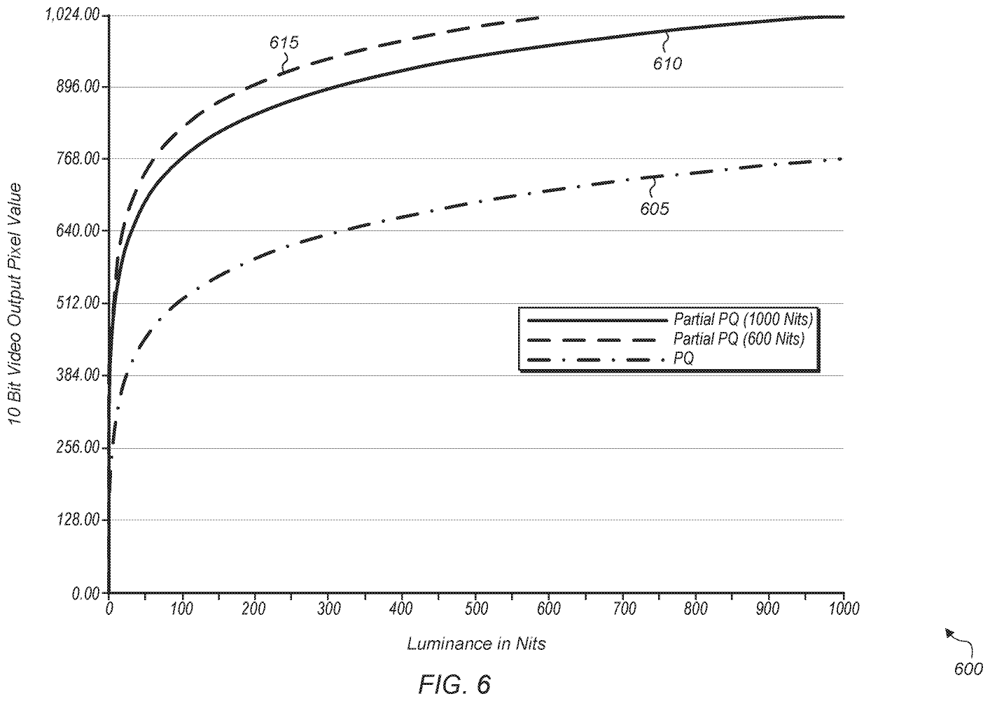

Turning now to FIG. 6, a diagram of one implementation of a graph 600 for remapping pixel values to a format adapted to a target display is shown. Graph 600 illustrates three different PQ curves which are able to be used for encoding pixel data for display. These curves are shown for 10-bit output pixel values. In other implementations, similar PQ curves for other bit sizes of output pixel values are utilized for other implementations.

The PQ curve 605 illustrates a typical PQ EOTF encoding which results in wasted code words which map to luminance values that cannot be displayed by limited luminance range displays. PQ curve 605 illustrates the same curve as the dashed-line curve shown in graph 500 (of FIG. 5). For target displays with a maximum luminance of 1000 nits, partial PQ curve 610 is utilized to map 10-bit output pixel values to luminance values. For partial PQ curve 610, the maximum 10-bit output pixel value of 1024 maps to a luminance of 1000 nits. This allows the entire range of output pixel values to map to luminance values that the target display is actually able to generate. In one implementation, partial PQ curve 610 is generated by scaling PQ curve 605 by a factor of 10 (10000 divided by 1000 nits).

For a target display with a maximum luminance of 1000 nits, partial PQ curve 610 is utilized to map 10-bit output pixel values to luminance values. For partial PQ curve 610, the maximum 10-bit output pixel value of 1024 maps to a luminance of 600 nits. This mapping results in the entire range of output pixel values generating luminance values that the target display is actually able to display. In one implementation, partial PQ curve 615 is generated by scaling PQ curve 605 by a factor of 50/3 (10000 divided by 600 nits). In other implementations, other similar types of partial PQ curves are generated to map output pixel values to luminance values for displays with other maximum luminance values besides 600 or 1000 nits.

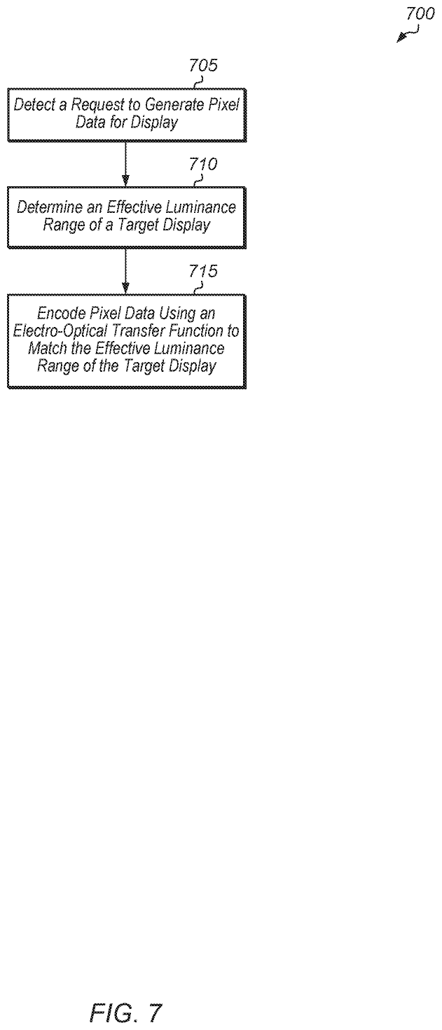

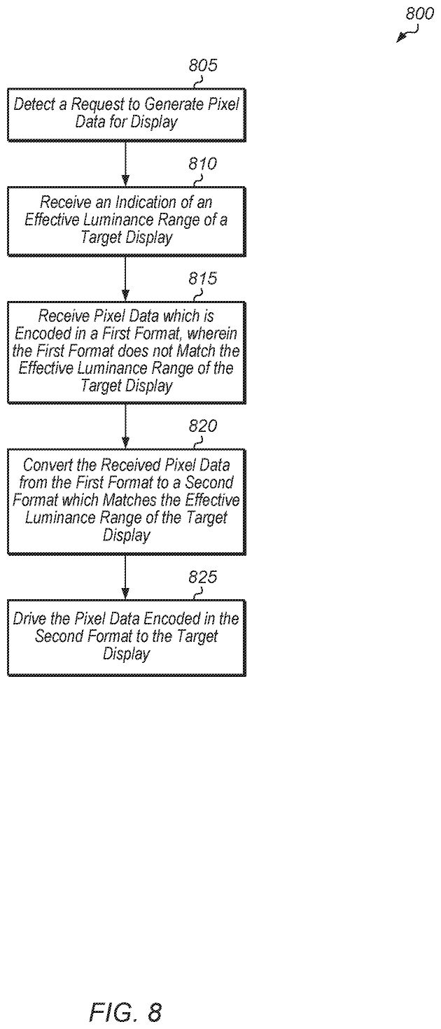

Referring now to FIG. 7, one implementation of a method 700 for using an effective electro-optical transfer function for limited luminance range displays is shown. For purposes of discussion, the steps in this implementation and those of FIG. 8-10 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 700.

A processor detects a request to generate pixel data for display (block 705). Depending on the implementation, the pixel data is part of an image to be display or the pixel data is part of a video frame of a video sequence to be displayed. Also, the processor determines an effective luminance range of a target display (block 710). In one implementation, the processor receives an indication of the effective luminance range of the target display. In other implementations, the processor determines the effective luminance range of the target display using other suitable techniques. In one implementation, the effective luminance range of the target display is specified as a pair of values indicative of a minimum luminance and a maximum luminance able to be generated by the target display.

Next, the processor encodes pixel data using an electro-optical transfer function (EOTF) to match the effective luminance range of the target display (block 715). In one implementation, encoding pixel data to match the effective luminance range of the target display involves mapping a minimum output pixel value (e.g., 0) to a minimum luminance value of the target display and mapping a maximum output pixel value (e.g., 0x3FF in a 10-bit format) to a maximum luminance value of the target display. Then, the output pixel values in between the minimum and maximum are scaled in between using any suitable perceptual quantizer transfer function or other type of transfer function. The perceptual quantizer transfer function distributes output pixel values in between the minimum and maximum output pixel values to optimize for human eye perception. In one implementation, the processor encodes pixel data in between the minimum and maximum values using a scaled PQ EOTF. After block 715, method 700 ends.

Turning now to FIG. 8, one implementation of a method 800 for performing format conversion for pixel data is shown. A processor detects a request to generate pixel data for display (block 805). Also, the processor receives an indication of an effective luminance range of a target display (block 810). Next, the processor receives pixel data which is encoded in a first format, wherein the first format does not match the effective luminance range of the target display (block 815). In other words, a portion of the code word range of the first format maps to luminance values outside of the effective luminance range of the target display. In one implementation, the first format is based on the Gamma 2.2 curve. In other implementations, the first format is any of various other types of formats.

Then, the processor converts the received pixel data from the first format to a second format which matches the effective luminance range of the target display (block 820). In one implementation, the second format uses the same or less than the number of bits per pixel component value as the first format. By matching the effective luminance range of the target display, the second format is a more bandwidth efficient encoding of the pixel data. In one implementation, the second format is based on a scaled PQ EOTF. In other implementations, the second format is any of various other types of formats. Next, the pixel data encoded in the second format is driven to the target display (block 825). After block 825, method 800 ends. Alternatively, the pixel data in the second format is stored or sent to another unit after block 820 rather than being driven to the target display.

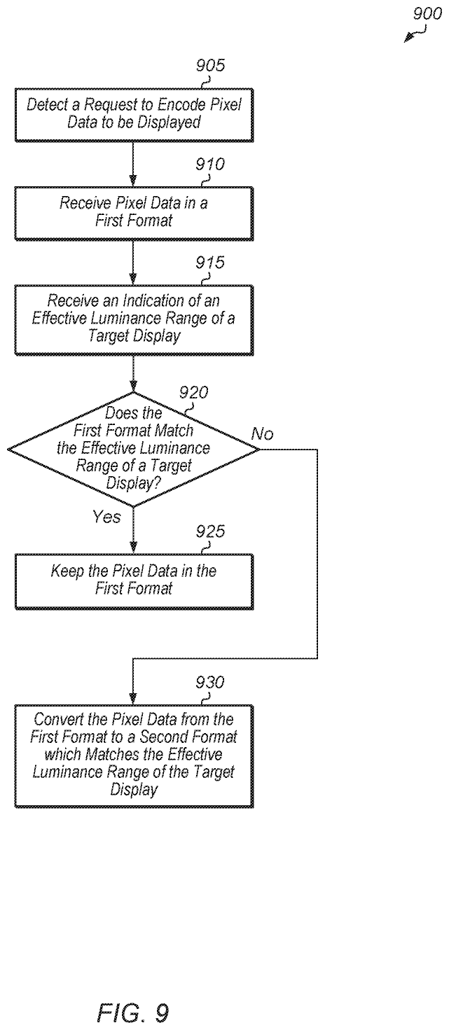

Referring now to FIG. 9, one implementation of a method 900 for processing pixel data is shown. A processor detects a request to encode pixel data to be displayed (block 905). Next, the processor receives pixel data in a first format (block 910). Alternatively, the processor retrieves, from a memory, the pixel data in the first format in block 910. The processor also receives an indication of the effective luminance range of a target display (block 915). The processor analyzes the pixel data to determine if the first format matches the effective luminance range of a target display (conditional block 920). In other words, the processor determines if the first format has a substantial portion of its output value range mapping to luminance values outside of the effective luminance range of the target display in conditional block 920. In one implementation, a “substantial portion” is defined as a portion which is greater than a programmable threshold.

If the first format matches the effective luminance range of a target display (conditional block 920, “yes” leg), then the processor keeps the pixel data in the first format (block 925). After block 925, method 900 ends. Otherwise, if the first format does not match the effective luminance range of the target display (conditional block 920, “no” leg), then the processor converts the received pixel data from the first format to a second format which matches the effective luminance range of the target display (block 930). After block 930, method 900 ends.

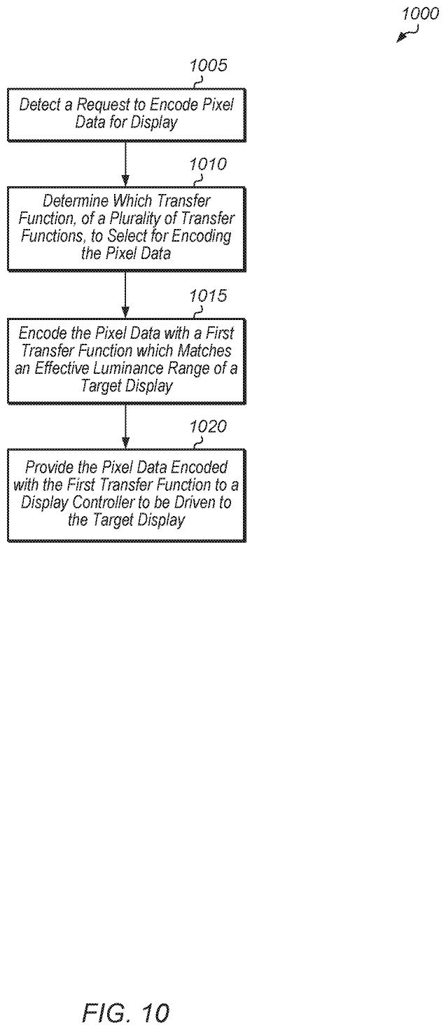

Turning now to FIG. 10, one embodiment of a method 1000 for selecting a transfer function for encoding pixel data is shown. A processor detects a request to encode pixel data to be displayed (block 1005). In response to detecting the request, the processor determines which transfer function, of a plurality of transfer functions, to select for encoding the pixel data (block 1010). Next, the processor encodes the pixel data with a first transfer function which matches an effective luminance range of a target display (block 1015). In one implementation, the first transfer function is a scaled version of a second transfer function. For example, in one implementation, the first transfer function maps code words to a first effective luminance range (0-600 nits) while the second transfer function maps code words to a second effective luminance range (0-10,000 nits). Then, the processor provides the pixel data encoded with the first transfer function to a display controller to be driven to the target display (block 1020). After block 1020, method 1000 ends.

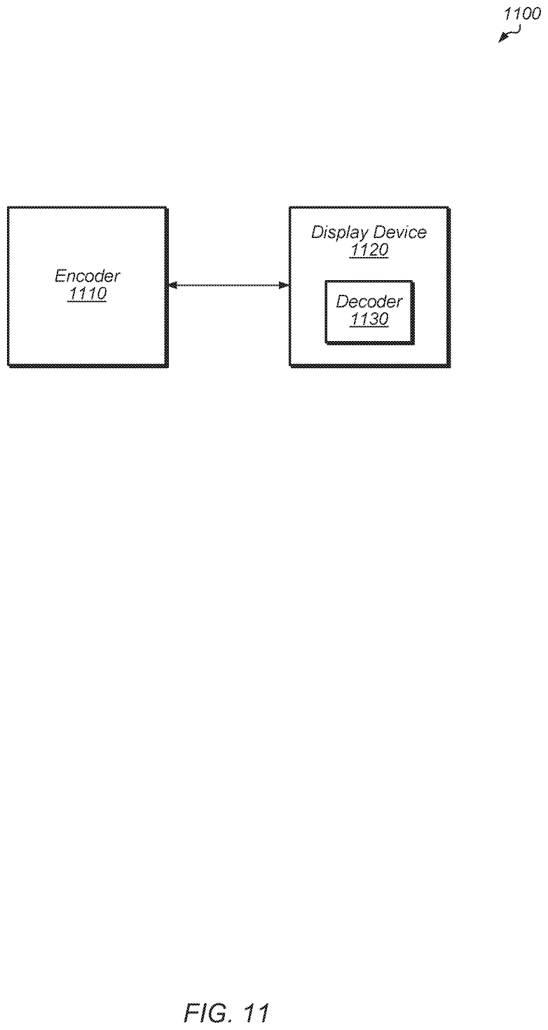

Referring now to FIG. 11, a block diagram of one implementation of a computing system 1100 is shown. In one implementation, computing system 1100 includes encoder 1110 coupled to a display device 1120. Depending on the implementation, encoder 1110 is directly coupled to display device 1120 or encoder is coupled to display device 1120 through one or more networks and/or devices. In one implementation, decoder 1130 is integrated within display device 1120. In various implementations, encoder 1110 encodes a video stream and conveys the video stream to display device 1120. Decoder 1130 receives and decodes the encoded video stream into a format which is able to be displayed on display device 1120.

In one implementation, encoder 1110 is implemented on a computer with a GPU, with the computer connected directly to display device 1120 through an interface such as DisplayPort or high-definition multimedia interface (HDMI). In this implementation, the bandwidth limitations for the video stream sent from encoder 1110 to display device 1120 would be the maximum bit rate of the DisplayPort or HDMI cable. In a bandwidth limited scenario where the video stream is encoded using low bit depth, the encoding techniques described throughout this disclosure can be advantageous.

In various implementations, program instructions of a software application are used to implement the methods and/or mechanisms described herein. For example, program instructions executable by a general or special purpose processor are contemplated. In various implementations, such program instructions are represented by a high level programming language. In other implementations, the program instructions are compiled from a high level programming language to a binary, intermediate, or other form. Alternatively, program instructions are written that describe the behavior or design of hardware. Such program instructions are represented by a high-level programming language, such as C. Alternatively, a hardware design language (HDL) such as Verilog is used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a memory;
a display controller; and
a processor coupled to the memory and the display controller, wherein the processor is configured to:
detect a request to encode pixel data to be displayed;
determine an effective luminance range of a target display;
identify a first transfer function of a plurality of available transfer functions, wherein the first transfer function matches the effective luminance range of the target display;
encode the pixel data with the first transfer function; and
provide the pixel data encoded with the first transfer function to the display controller to be driven to the target display.

2. The system as recited in claim 1, wherein the first transfer function is a scaled version of a second transfer function.

3. The system as recited in claim 2, wherein the second transfer function maps a subset of code words to luminance values outside of the effective luminance range of the target display.

4. The system as recited in claim 1, wherein the first transfer function:
maps a minimum code word to a minimum luminance output that can be displayed by the target display;
maps a maximum code word to a maximum luminance output that can be displayed by the target display; and
distributes code words in between the minimum code word and the maximum code word to optimize for human eye perception.

5. The system as recited in claim 1, wherein the processor is configured to receive an indication of the effective luminance range of the target display.

6. The system as recited in claim 1, wherein encoding the pixel data with the first transfer function results in an entire range of code words being mapped to luminance values that the target display is able to generate.

7. The system as recited in claim 1, wherein the processor is further configured to convey, to a decoder, an indication that the pixel data has been encoded with the first transfer function.

8. A method comprising:
detecting a request to encode pixel data to be displayed;
determining an effective luminance range of a target display;
identifying a first transfer function of a plurality of available transfer functions, wherein the first transfer function matches the effective luminance range of the target display;
encoding the pixel data with the first transfer function; and
providing the pixel data encoded with the first transfer function to a display controller to be driven to the target display.

9. The method as recited in claim 8, wherein the first transfer function is a scaled version of a second transfer function.

10. The method as recited in claim 9, wherein the second transfer function maps a subset of code words to luminance values outside of the effective luminance range of the target display.

11. The method as recited in claim 8, wherein the first transfer function:
maps a minimum code word to a minimum luminance output that can be displayed by the target display;
maps a maximum code word to a maximum luminance output that can be displayed by the target display; and
distributes code words in between the minimum code word and the maximum code word to optimize for human eye perception.

12. The method as recited in claim 8, further comprising receiving an indication of the effective luminance range of the target display.

13. The method as recited in claim 8, wherein encoding the pixel data with the first transfer function results in an entire range of code words being mapped to luminance values that the target display is able to generate.

14. The method as recited in claim 8, further comprising conveying, to a decoder, an indication that the pixel data has been encoded with the first transfer function.

15. A processor comprising:
a memory; and
a plurality of compute units;
wherein the processor is configured to:
detect a request to encode pixel data to be displayed;
determine an effective luminance range of a target display;
identify a first transfer function of a plurality of available transfer functions, wherein the first transfer function matches the effective luminance range of the target display;
encode the pixel data with the first transfer function; and
provide the pixel data encoded with the first transfer function to the display controller to be driven to the target display.

16. The processor as recited in claim 15, wherein the first transfer function is a scaled version of a second transfer function.

17. The processor as recited in claim 16, wherein the second transfer function maps a subset of code words to luminance values outside of the effective luminance range of the target display.

18. The processor as recited in claim 15, wherein the first transfer function:
maps a minimum code word to a minimum luminance output that can be displayed by the target display;
maps a maximum code word to a maximum luminance output that can be displayed by the target display; and
distributes code words in between the minimum code word and the maximum code word to optimize for human eye perception.

19. The processor as recited in claim 15, wherein the processor is configured to receive an indication of the effective luminance range of the target display.

20. The processor as recited in claim 15, wherein encoding the pixel data with the first transfer function results in an entire range of code words being mapped to luminance values that the target display is able to generate.
